(19) United States
(12) Patent Application Publication
(10) Pub. No.: US 2020/0118097 A1
(43) Pub. Date: Apr. 16, 2020

(54) VALUE-ADDED SERVICES ENABLED BY A CLOUD-BASED PAYMENT SYSTEM

(71) Applicant: The Toronto-Dominion Bank, Toronto (CA)

(72) Inventors: Jeffrey Aaron Ecker, North York (CA); Bryan Michael Gleeson, Bowmanville (CA); Adam Douglas McPhee, Waterloo (CA); Matta Wakim, Petersburg (CA); Kyryll Odobetskiy, Waterloo (CA); John Jong-Suk Lee, Toronto (CA)

(21) Appl. No.: 16/156,508

(22) Filed: Oct. 10, 2018

(51) Int. Cl. G06Q 20/10; G06Q 20/08

(52) U.S. Cl. CPC G06Q 20/10; G06Q 20/085

(57) ABSTRACT

The present disclosure involves systems, software, and computer implemented methods for identifying and performing value-added services (VAS) based on detailed transactional information received from a cloud-based payment system. In one example, a set of standard transaction information defining a transaction received via the cloud-based payment services system is received in a first channel, and is associated with a first unique identifier. A set of detailed transaction information associated with the transaction different from the set of transaction information can be received in a second channel. The set of standard transaction information can be associated with the set of detailed transaction information to a particular transaction based on a relationship between a first unique identifier of the standard transaction information and a second unique identifier of the detailed transaction information. An automatic analysis identifies a transaction-based value-added service to be performed for the particular transaction, which can then be initiated.

### TECHNICAL FIELD

The present disclosure relates to computer-implemented methods, software, and systems for identifying and performing value-added services (VAS) based on detailed transactional information received from a cloud-based payment system.

### BACKGROUND

Current transactional systems allows merchants to capture transactional information and provide that captured transactional information to payment processors for payment processing. However, obtaining detailed transactional information is difficult, as only a basic set of information is provided for processing particular transactions. Information related to inventory, purchased items or services, and tax information are not available in the information provided to the payment processor. In particular, the basic set of information usually received in a transaction may be considered Level 1, or Level I, data. Level 1 transaction data associated with consumer transactions provides limited purchase data, and includes the same information captured during a traditional credit card purchase transaction. The information captured includes a total purchase amount, a date of the transaction, and a supplier/retailer name (e.g., also identified at or by the POS).

### SUMMARY

The present disclosure involves systems, software, and computer implemented methods for identifying and performing value-added services (VAS) based on detailed transactional information received from a cloud-based payment system. A first example system includes a communications module, at least one memory storing instructions, a plurality of account profiles, and a repository of transaction-based value added service definitions, and at least one hardware processor interoperably coupled with the at least one memory and the communications module. Each transaction-based value added service definition defines at least one automatic operation to be performed based on a set of criteria associated with at least one particular transaction and a corresponding set of information associated with the particular transaction. The instructions can instruct the at least one hardware processor to perform various operations, including receiving, via the communications module and in a first channel from a cloud-based payment services system, a set of standard transaction information defining a first transaction received via the cloud-based payment services system, where the set of standard transaction information associated with a first unique identifier. Further, a set of detailed transaction information associated with the first transaction different from the set of transaction information can be received, via the communications module and in a second channel from the cloud-based payment services system. The set of detailed transaction information can be associated with a second unique identifier, and the second channel can be different than the first channel. The received set of standard transaction information can be associated with the received set of detailed transaction information to a particular transaction based on a relationship between the first and second unique identifiers. The received set of standard transaction information and the received set of detailed transaction information can be automatically analyzed to identify at least one transaction-based value-added service to be performed for the particular transaction, and the at least one identified transaction-based value-added service can be initiated.

Implementations can optionally include one or more of the following features.

In some instances, the received set of standard transaction information can comprise Level 1 card data associated with the first transaction, wherein the set of detailed transaction information associated with first transaction comprises at least one of Level 2 or Level 3 card data associated with the first transaction.

In some instances, the first channel can comprise a payment verification channel from the cloud-based payment services system to a financial institution, and the second channel can be output from a value-added service application programming interface from the cloud-based payment services system.

In some instances, the first unique identifier of the received set of standard transaction information and the second unique identifier of the received set of detailed transaction information comprise a unique transaction identifier, where associating the received set of standard transaction information and the received set of detailed transaction information to a particular transaction based on a relationship between the first and second unique identifiers comprises matching the first and second unique identifiers.

In some instances, the first unique identifier of the received set of standard transaction information comprises a transaction identifier and the second unique identifier of the received set of detailed transaction information comprises a merchant identifier. The received set of standard transaction information can include a timestamp of the transaction, and the received set of detailed transaction information can include a timestamp. Associating the received set of standard transaction information and the received set of detailed transaction information to a particular transaction based on a relationship between the first and second unique identifiers can comprise determining a merchant identifier associated with the transaction identifier and matching the timestamp of the received set of standard transaction information to the timestamp of the received set of detailed transaction data.

In some instances, at least some of the transaction-based value added service definitions are associated with criteria evaluated based on the particular set of standard transaction and detailed transaction data associated with a particular transaction in combination with an analysis of that particular transaction in relation to a historical set of transactions associated with the account profile of a particular merchant associated with the particular transaction. In some of those instances, initiating the at least one identified transaction-based value-added service comprises identifying, based on the particular set of standard transaction and detailed transaction data associated with a particular transaction in combination with an analysis of that particular transaction in relation to a historical set of transactions associated with the account profile of a particular merchant associated with the particular transaction, where at least one financial product associated with the merchant to be offered, generating an offer based on the at least one identified financial product, and transmitting, via communications module, a message to the cloud-based payment services system including the generated offer.

In some instances, initiating the at least one identified transaction-based value-added service comprises identifying, based on the particular set of detailed transaction data associated with a particular transaction, a set of goods transacted in the particular transaction, analyzing a merchant account identifying a current stock associated with goods offered by the merchant, determining, from the merchant account, that additional stock of at least one of the set of goods transacted in the particular transaction is to be replenished based on an amount of the set of goods transacted, and automatically initiating a replenishment operation based on the amount of the set of goods transacted in the particular transaction and on the determination.

Similar operations and processes may be performed in a different system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. Additionally, similar operations can be associated with or provided as computer implemented software embodied on tangible, non-transitory media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example system for identifying and performing value-added services (VAS) based on detailed transactional information received from a cloud-based payment system.

FIG. 2 is an illustration of components and interactions performed in an example system for identifying and performing VASs based on detailed transactional information received at a cloud-based payment system.

FIG. 3 is a flow diagram of an example method for identifying and performing VASs based on detailed transactional information received from a cloud-based payment system in one particular example implementation.

### DETAILED DESCRIPTION

The present disclosure describes various tools and techniques associated with identifying and performing value-added services (VAS) based on detailed transactional information received from a cloud-based payment system. In particular, the present solution is meant to leverage newly provided cloud-based payment systems coupled to merchant systems in an effort to allow the financial institution associated with the cloud-based payment system, or the cloud-based payment system itself, to identify, initiate, and execute one or value-added services.

The present solution takes advantage of cloud-based payment or point-of-sale (POS) systems, where the cloud-based payment solutions allow merchants to purchase a dummy card reading device and download corresponding POS software to a client system. The POS software executing at the client system can connect to the dummy card reading device, load required software, keys, and credentials, and can begin using the dummy card reading device as a dummy POS using the POS software to perform transactions in short order. In general, the solution may use a mobile merchant services platform that enables powerful partnering options within a merchant services ecosystem. By connecting banks, acquirers, retailers, and value-added services to deliver services in demand for mobile merchants, the cloud-based payment solution allows rapid transformation of payment architectures and solutions. In some examples, the cloud-based payment solution may provide or be associated with a mobile commerce platform. In some instances, the cloud-based payment solution can remove vendor locks to particular POS devices, and can instead allow merchants to use a dummy POS to interact with a backend merchant system or the client device. This use of the dummy POS can reduce costs, allowing any suitable POS to be used, where the encryption and security is based on a POS application and the connection with POS application (and client device) provides the necessary security for obtaining card transaction data.

Further, the cloud-based payment solution can use a backend financial institution or other payment processor to receive payment information through a payment gateway. Standard transaction data, which may be considered Level 1 data, may include a total purchase amount, a date of the transaction, and a supplier/retailer name (e.g., also identified at or by the POS). That information can be used by the payment processor to process and complete the transaction. In addition, and based on the POS and POS software's link to the transactional systems, the cloud-based payment system may be able to capture additional information regarding the transaction. In doing so, the POS or client device can forward the additional transaction information to a cloud-based payment application or application server. That cloud-based payment application or application server can push the standard transaction data to the payment processor, while providing, via one or more application programming interfaces (APIs) or other suitable components, additional detailed transactional data to one or more value-added processors. In some instances, a value-added processing system may be incorporated in or associated with the payment processor, such as a financial institution at which the payment processing is performed. Additionally or alternatively, the value-added processing system may be associated with the cloud-based payments system, and allow connections to one or more third party applications and services (e.g., accounting services).

In situations where the value-added processor is associated with a financial institution acting as the payment processor for the cloud-based payment system, the standard transaction data and the detailed transaction data can be correlated when received through two or more different communication channels (e.g., a payment processing channel and a value-added services channel via an API of the cloud-based payment system). By correlating identifiers between the sets of information, a clearer and more detailed transactional set of information can be obtained. Using that correlated information, alone or along with historical or additional information about the merchant stored at or managed by the financial institution, one or more additional value-added services can be identified and initiated by the value-added processor. The value-added services can include, without limitation, a financial product offering, a business analytical evaluation of the merchant over time, a trend analysis of merchant business, customer feedback, competitor comparisons or analysis, a supply chain analysis and processing, or any other suitable service. By incorporating available historical information together with the correlated transactional information, real-time analyses and feedback can be provided in connection with a previously simple payment processing service.

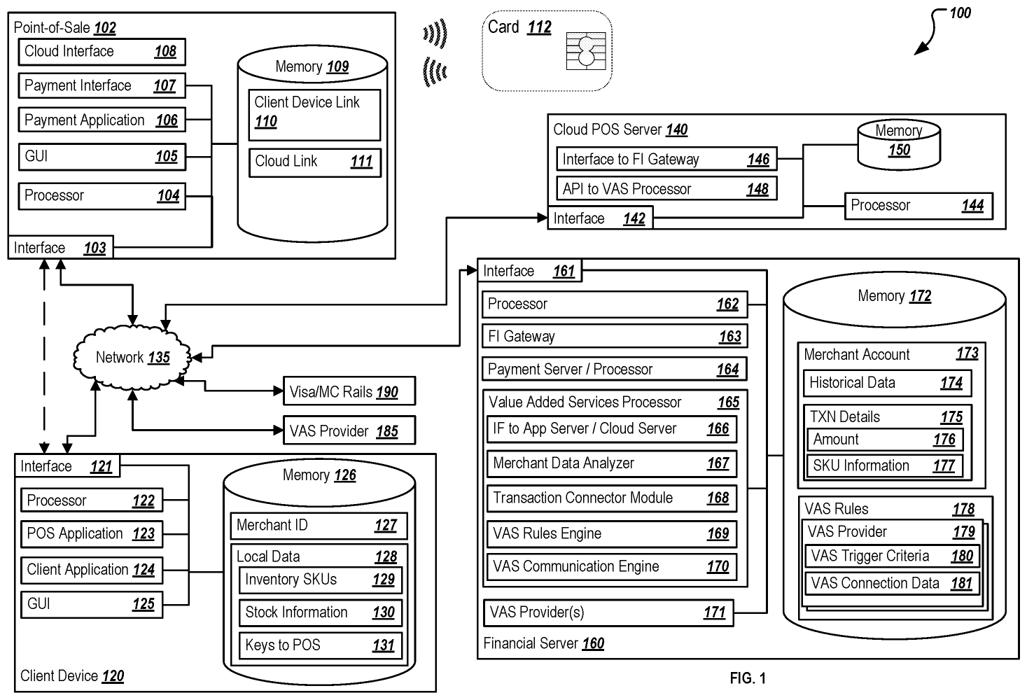

Turning to the illustrated example implementation, FIG. 1 is a block diagram illustrating an example system 100 for identifying and performing value-added services (VAS) based on detailed transactional information received from a cloud-based payment system. System 100 includes functionality and structure associated with a cloud-based payment system allowing merchants to receive payment transactions at a point-of-sale (POS) 102 linked to a client device 120 executing a POS application 123, where details of the transaction are provided to a cloud-based POS server 140. The cloud-based POS server 140 acts as a payment system for the POS 102 and POS application 123, and can provide transaction information to a financial institution via a financial institution gateway (or FI gateway) 163, which routes transaction information to one or more payment servers or processors 164 executed by or associated with a financial server 160 of a financial institution. The data provided to the FI gateway 163 represents standard transaction data, which may be similar to or comprise Level 1 card data. Using this information, the payment server 164 can process the transaction using a corresponding payment rail, such as a Visa or MasterCard payment rail 190.

In addition to the standard transaction data, additional detailed transaction data can captured by the POS 102 and POS application 123, which can then be provided to the cloud POS server 140. The cloud POS server 140 can provide, via one or more APIs, additional detailed transactional information to the financial server 160, and particularly to a value-added services processor (VAS processor) 165 associated with the financial server 160. The VAS processor 165 or an associated component can use unique identifiers and/or information associated with the standard transaction data and the detailed transaction data to correlate transactions, and then subsequently perform a value-added service analysis to determine which, if any, VASs are to be used in association with or in response to a particular transaction. The VAS processor 165 can then initiate the identified VAS operations, either using an internal VAS provider 171 internal to or associated with the financial server 160, or using an external and/or third party VAS provider 185.

The components of system 100 can communicate with each other via network 135, through which each of the components may be communicably connected. Network 135 facilitates wireless or wireline communications between the components of the environment 100 (e.g., between combinations of the POS 102, client device 120, financial server 160, cloud POS server 140, and/or the other components, among others) as well as with any other local or remote computer, such as additional mobile devices, clients, servers, remotely executed or located portions of a particular component, or other devices communicably coupled to network 135, including those not illustrated in FIG. 1. In the illustrated environment, the network 135 is depicted as a single network, but may be comprised of more than one network without departing from the scope of this disclosure, so long as at least a portion of the network 135 may facilitate communications between senders and recipients. In some instances, one or more of the illustrated components (e.g., the cloud POS server 140 or other components) or portions thereof may be included within network 135 as one or more cloud-based services or operations. The network 135 may be all or a portion of an enterprise or secured network, while in another instance, at least a portion of the network 135 may represent a connection to the Internet. In some instances, a portion of the network 135 may be a virtual private network (VPN) or an Intranet. Further, all or a portion of the network 135 can comprise either a wireline or wireless link, including wireless links (e.g., Bluetooth, NFC) between linked components (such as POS 102 and client device 120). Example wireless links may include 802.11a/b/g/n/ac, 802.20, WiMax, LTE, and/or any other appropriate wireless link. In other words, the network 135 encompasses any internal or external network, networks, sub-network, or combination thereof operable to facilitate communications between various computing components inside and outside the illustrated environment 100. The network 135 may communicate, for example, Internet Protocol (IP) packets, Frame Relay frames, Asynchronous Transfer Mode (ATM) cells, voice, video, data, and other suitable information between network addresses. The network 135 may also include one or more local area networks (LANs), radio access networks (RANs), metropolitan area networks (MANs), wide area networks (WANs), all or a portion of the Internet, and/or any other communication system or systems at one or more locations.

As illustrated, system 100 includes or is communicably coupled with one or more POSs 102, a client device 120, a financial server 160, and a cloud POS server 140, each connected via network 135. System 100 is a single example of a possible implementation, with alternatives, additions, and modifications possible for performing some or all of the described operations and functionality. Although other components are shown separately, in some implementations, functionality of two or more systems, servers, or illustrated components may be provided by a single system or server. In some implementations, the functionality of one illustrated system or server may be provided by multiple systems, servers, or computing devices, including those physically or logically local or remote to each other. For example, financial server 160 may actually be represented by multiple servers and other components in other instances. Any combination or permutation of systems may perform the functionality described herein. In some instances, particular operations and functionality described herein may be executed at either the POS 102, the client device 120, financial server 160, or the cloud POS server 140, or at one or more other non-illustrated components, as well as at a combination thereof.

As used in the present disclosure, the term “computer” is intended to encompass any suitable processing device. For example, POS 102, client device 120, the financial server 160, and the cloud POS system 140 may each be any computer or processing device (or combination of devices) such as, for example, a blade server, general-purpose personal computer (PC), Mac®, workstation, UNIX-based workstation, embedded system or any other suitable device. Moreover, although FIG. 1 illustrates particular components as a single element, those components may be implemented using a single system or more than those illustrated, as well as computers other than servers, including a server pool or variations that include distributed computing. In other words, the present disclosure contemplates computers other than general-purpose computers, as well as computers without conventional operating systems. POS 102 may be any system which can receive payment information via a payment interface 107 (e.g., from a card 112), execute an application (e.g., payment application 106) associated with interpreting the payment information, and/or interact with the client device 120 and the cloud POS server 140 to perform a financial transaction associated with the merchant. The POS 102 may be a dedicated device associated with a particular cloud POS system 140, or may be a generic POS 102 (e.g., a PIN pad with a card reader) without a vendor or POS system lock. The POS 102 can be securely connected or linked to a client device 120, allowing the client device 120 and the POS 102 to securely exchange information associated with merchant transactions. In some instances, the POS 102 may be an attachment to or an accessory of the client device 120, such that, through secure physical connections, information can be captured by the POS 102 and turn the client device 120 into its own POS. In other instances, the POS 102 may be a separate device from the client device 120, where the POS 102 and client device 120 communicate securely using encrypted local wireless or wired communications. As illustrated, POS 102 represents a mobile POS, but could also represent a stationary component physically connected to a location.

As illustrated, POS 102 includes an interface 103, at least one processor 104, GUI 105, payment application 106, payment interface 107, and a cloud interface 108, along with memory 109. Interface 103 is used by the POS 102 for communicating with other systems in a distributed environment—including within the environment 100—connected to the POS 102 and/or network 135, e.g., client device 120, financial server 160 and/or the cloud POS server 140, as well as other systems or components communicably coupled to the network 135. Generally, the interface 103 comprises logic encoded in software and/or hardware in a suitable combination and operable to communicate with the network 135 and other communicably coupled components, including a locally connected client device 120. More specifically, the interface 103 may comprise software supporting one or more communication protocols associated with communications such that the payment application 106, cloud interface 108, the network 135, and/or the interface's hardware is operable to communicate physical signals within and outside of the illustrated environment 100.

Payment interface 107 may be any suitable interface used to receive and/or input transaction information and transaction credentials from one or more users or customers of the merchant associated with the POS 102. As illustrated, the payment interface 107 may read or receive information from one or more credit or debit cards 112, mobile devices (e.g., mobile phones with a mobile wallet), and/or other components. The information may be received via a card swipe, an NFC interaction (e.g., using a smart card or a mobile device), or any other suitable interaction. In some instances, the POS 102 may be associated with a cloud- or internet-based payment input, allowing inputs to be received via suitable Internet-connected web pages and/or apps which can provide information to the POS 102. Using information obtained from the interaction, the payment interface 107 can provide the information to the payment application 106, which can share the information with a POS application 123 at the client device 120 for further processing. In some instances, the POS 102 may obtain information from the client device 120 regarding the transaction, and can connect to the cloud POS server 140 via the cloud interface 108 to securely provide standard transaction information for processing. In some instances, the payment application 106 may also provide detailed transaction data or information to the cloud POS server 140 (e.g., as determined at the POS 102, or as obtained from the client device 120), where the detailed transaction data represents additional information not included in the standard transaction information, and that can be used to identify or enhance transactions through one or more value-added services. Cloud interface 108 may represent a secure connection or interface through which the POS can connect to and communicate with the cloud POS server 140. In some instances, the client device 120 may perform communications with the cloud POS server 140 instead, with the POS 102 performing only local communication to the client device 120.

The POS 102 may include any suitable input components used to receive information and interact with customers, including transaction and card-specific data. For example, a keypad, touchscreen, camera, microphone, or other input components may be included in the POS 102. Additionally, one or more output components used to convey information associated with the POS 102 and its applications, including any loyalty offers, can be included with the POS. Example output components may include, but are not limited to, a display, one or more speakers, or any other suitable output components. The display may be associated with GUI 105, and can present digital data and visual information, while other output components can provide auditory or tactile feedback. GUI 105 can interface with at least a portion of the environment 100 for any suitable purpose, including generating a visual representation of any screens or displays associated with the POS 102 and the payment application 106, including presentation of a pop-up or push notification or preview, presenting a UI associated with the transaction and the payment application 106, or the remote POS application 123, or any other suitable presentation of information. GUI 105 may also be used to view and interact with various Web pages, applications, and Web services located local or external to the POS 102, such as those related to or associated with either the merchant or the financial institution. Generally, the GUI 105 provides the user with an efficient and user-friendly presentation of data provided by or communicated within the system. The GUI 105 may comprise a plurality of customizable frames or views having interactive fields, pull-down lists, and buttons operated by the user. For example, the GUI 105 may provide interactive elements that allow a user to view or interact with information related to the operations of processes associated with the cloud POS server 140, the financial server 160, and any associated systems, among others. In general, the GUI 105 is often configurable, supports a combination of tables and graphs (bar, line, pie, status dials, etc.), and is able to build real-time portals, application windows, and presentations. Therefore, the GUI 105 contemplates any suitable graphical user interface, such as a combination of a generic web browser, a web-enabled application, intelligent engine, and command line interface (CLI) that processes information in the platform and efficiently presents the results to the user visually.

POS 102 also includes one or more processors 104. Although illustrated as a single processor 104 in FIG. 1, multiple processors may be used according to particular needs, desires, or particular implementations of the environment 100. Each processor 104 may be a central processing unit (CPU), an application specific integrated circuit (ASIC), a field-programmable gate array (FPGA), or another suitable component. Generally, the processor 104 executes instructions and manipulates data to perform the operations of the POS 102, in particular those related to executing the various modules illustrated therein and their related functionality. Specifically, the processor 104 executes the algorithms and operations described in the illustrated figures and description, as well as the various software applications, modules, and functionality, including the functionality for sending communications to and receiving transmissions from various components in the illustrated system 100, as well as to process transactions via the payment interface 107 and the payment application 106, among others. Each processor 104 may have a single core or multiple cores, with each core available to host and execute an individual processing thread.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component may be fully or partially written or described in any appropriate computer language including C, C++, Objective-C, JavaScript, Java™, Visual Basic, assembler, Perl®, Swift, HTML5, any suitable version of 4GL, as well as others.

As illustrated, the POS 102 includes memory 109. In some implementations, the POS 102 includes a single memory or multiple memories. The memory 109 may include any type of memory or database module and may take the form of volatile and/or non-volatile memory including, without limitation, magnetic media, optical media, random access memory (RAM), read-only memory (ROM), removable media, or any other suitable local or remote memory component. The memory 109 may store various objects or data, including caches, classes, frameworks, applications, backup data, business objects, jobs, web pages, web page templates, database tables, database queries, repositories storing business and/or dynamic information, and any other appropriate information including any parameters, variables, algorithms, instructions, rules, constraints, or references thereto associated with the purposes of the POS 102. Additionally, the memory 109 may store any other appropriate data, such as VPN applications, firmware logs and policies, firewall policies, a security or access log, print or other reporting files, as well as others. As illustrated, memory 109 includes, for example, a client device link 110 and a cloud link 111, among others. The client device link 110 may include or identify particular encryption keys and security information specific to the client device 120 (e.g., keys to POS 131), where the client device link 110 associates the POS 102 with the client device 120 and allows secure and protected communication between the components for purposes of completing one or more transactions. The cloud link 111 can store or identify information associated with the cloud POS server 140, allowing in some instances, the POS 102 to communicate with the cloud POS server 140 via network 135. In some instances, the POS 102 may also store transaction information associated with a current and/or prior transactions, including in a transaction cache. The transaction cache can be stored in a secure storage environment or component according to PCI DSS requirements, and tokenization can be used so that no cardholder data is available in the clear. Other or alternative security techniques and protections can be applied to protect customer and merchant data. Information about those transactions can be maintained until the transactions are complete, and can be deleted or otherwise moved once those transactions are finished. In some instances, some or all of the data included in memory 109 in FIG. 1 may be located outside of the POS 102, including within network 135 as cloud-based storage and data, at the client device 120, or elsewhere, where appropriate.

As described, the POS 102 can be linked to or associated with a particular client device 120. The client device 120 may be any other suitable device, including a mobile device, such as a smartphone, a tablet computing device, a smartwatch, a laptop/notebook computer, or a connected device, where those devices interact with and can manage one or more POSs 102. The client device 120 may be used exclusively for purposes of performing merchant transactions, or the client device 120 may include additional and alternative functionality for additional tasks. The client device 120 may be a desktop or workstation, server, or any other type of suitable device, as well as a device specifically designed to interact or work with the financial server 160. The client device 120, and other illustrated components, may be adapted to execute any suitable operating system, including Linux, UNIX, Windows, Mac OS®, Java™, Android™, Windows Phone OS, iOS™, a proprietary operating system and/or applications, among others.

As illustrated, client device 120 includes interface 121 (which may be similar to or different than interface 103), and can allow the client device 120 to communicate via network 135 with other components, as well as directly to POS 102 in some instances. Processor 122, which may be similar to or different than processor 104, can execute the client device 120 operations and functionality, including the POS application 123 and one or more client applications 124. The POS application 123 can be used to interact with the POS 102, and may be associated with the payment application 107 of the POS 102. In some instances, the payment application 107 may be a remote portion of, a copy of, or an agent of the POS application 123. The POS application 123 can be used by the client device 120 to allow the POS 102 to interact with the client device 120, and can, in some instances, manage the transaction at the POS 102 from the client device 120 via the payment application 106. Further, the POS application 123 may, in some instances, manage communication operations associated with the transaction to the cloud POS server 140, where the POS application 123 provides the standard transaction data and any suitable detailed transaction data to the cloud POS server 140, where the cloud POS server 140 provides the standard transaction data to the FI gateway 163 for processing, and transmits or makes available the detailed transaction data to the VAS processor 165 and/or one or more VAS providers 171, 185.

The client application 124 may be any other application executing at the client device 120, and can include applications associated with one or more VAS providers 171, 185, one or more non-transaction-related applications, as well as applications associated with the merchant's business, including applications related to inventory, services, or other items offered by the merchant associated with the client device 120. In some instances, the client application 124 may be multiple applications, and may be a link to, agent of, or remote portion of one or more backend applications where merchant operations are performed and further information is stored.

GUI 125 may be similar to or different from GUI 105, and can provide visualizations and information associated with the POS application 123, one or more client applications 124, or any other function or application of the client device 120.

Memory 126 of the client device 120 may be similar to or different from memory 109 of the POS 102, and may include information relevant to the POS application 123, one or more client applications 124, and other information associated with the merchant. For example, memory 126 as illustrated includes a merchant ID 127 that can be associated with information provided to the cloud POS server 140, such as either standard or detailed transaction information. Similarly, particular transactions may be associated with transaction identifiers to uniquely identify those transactions when processing the payment and the value-added services. In some instances, different portions of the data may be associated with different identifiers, where the financial server 160, upon receiving the information, can determine how received data is correlated. Additionally, memory 126 includes sets of local data 128, which may be associated with the merchant, and may be included in or associated with particular transactions. For example, a set of inventory SKUs 129 and stock information 130 associated with particular goods or items may be stored at the client device 120, or otherwise available via one or more other applications or systems. This information can be shared with the cloud POS server 140 based on transaction particulars, or can be accessed or provided to VAS providers 171, 185 to perform additional business analyses, where appropriate. The local data 128 may also include one or more keys 131 to the POS 102, such as encryption keys or other information used by the POS application 123 to communicate with the POS 102, and to allow the POS 102 to encrypt and otherwise protect information associated with particular transactions.

Cloud POS server 140 may be associated with or can execute cloud middleware related to the transaction operations performed by the POS 102 and the client device 120. The cloud POS server 140 may communicate with the POS 102 and/or the client device 120 using point-to-point encryption or other security measures, and can receive information about the transaction being performed. In addition to the standard transaction data (e.g., amount spent, date/time, etc.) used to process the payment or transaction, the cloud POS server 140 may receive or be able to access additional detailed information from the client device 120. Such information may include Level 2 or Level 3 information obtained in association with an executed transaction, as well as information specific to the merchant or otherwise not included in the standard transaction data. In some instances, the cloud POS server 140 may be a cloud-based solution executing within network 135. In general, the cloud POS server 140 provides, in whole or in part, a cloud-based payment solution along with the client device 120 (and its POS application 123) and the POS 102.

As illustrated, the cloud POS server 140 includes an interface 146 to an FI gateway 163 associated with financial server 160. The interface 146 may be used to format and prepare transaction processing request messages based on information received at the cloud POS server 140 regarding transactions to be processed. The interface 146 can perform operations to modify or enhance transaction information, and can forward the modified information to the FI gateway 163 for further processing.

The cloud POS server 140 also includes an interface 148 to one or more VAS processors. The interface 148 may be an API used to share detailed transaction information with a VAS processor 165 executing at the financial server 160, where the VAS processor 165 can combine the detailed transaction information with the standard transaction information provided via the FI gateway 163 to generate a detailed view of the transaction for further processing. In some instances, the interface 148 can share detailed transaction information with additional VAS processors other than VAS processor 165, including specific VAS providers 185 external to the financial server 160 and/or unrelated to the financial institution.

Memory 150 may be similar to or different from memories 109, 126, and can store information relevant to the cloud POS server 140. In some instances, memory 150 may include information relevant to the cloud POS server 140, including storing original transaction data received from the client device 120 and/or the POS 102, as well as information identifying particular communication endpoints and settings associated with a variety of components.

The financial server 160 of FIG. 1 represents one or more servers, systems, or other components that perform operations associated with a financial institution to assist in processing one or more merchant transactions by providing a FI gateway 163 and payment processor 164, as well as to provide additional value-added processing and services based on an analysis of one or more transactions as correlated at the backend system. The financial server 160 may be separate from the cloud POS server 140 other than being the system at which the payment processing is performed. In some instances, the VAS processor 165 may be a later-added component to the financial server 160, where the financial server 160 previously performed payment processing for the cloud POS server 140 and its POS 102 operations.

As illustrated, the financial server 160 includes an interface 161 (which may be similar to or different than interface 103, 121), a processor 162 (which may be similar to or different than processor 104, 122), the FI gateway 163, a payment processor 164, a value-added services processor 165, one or more VAS providers 171, and memory 172 (which may be similar to or different than memories 109, 126, 150). Different implementations may include additional or alternative components, with FIG. 1 meant to be an example illustration of one possible implementation. While illustrated separate from one another, at least some of these described elements may be combined within a single component or system, or may be implemented separate from one another, including at different systems, computers, and/or at remote components.

The FI gateway 163, as described, may be a payment gateway provided by the financial server 160 or associated financial institution used to authorize credit card, debit card, and other payments. The FI gateway 163, maybe separate from or associated with a payment processor 164, where the FI gateway 163 facilitates a payment transaction by the transfer of information from the cloud POS server 140 to the payment processor 164. The FI gateway 163 may act as a general recipient of information from the cloud POS server 140, and can forward the received information to the payment processor 164, which can facilitate the ultimate payment processing functionality via an appropriate payment rail, such as the Visa/MasterCard rails 190.

The value-added services (VAS) processor 165 can be any software application or component capable of receiving detailed transaction data from the cloud POS server 140 and using that data, along with the standard transaction data, to perform a VAS provider analysis to determine whether any particular VAS operations are triggered based at least on the current transaction. The interface to the cloud POS server 166 can be connected to or access the interface to the VAS processor 148 via network 135. Using those interfaces, which may be any suitable connection between the components, including one or more APIs, the detailed transaction data can be provided or otherwise obtained by the financial server 160. As described, standard transaction data can be obtained through a first channel (e.g., via the FI gateway 163), while the detailed transaction data, which can include Level 2 or Level 3 data, can be obtained through a different, second channel as described herein, such as through the interface to the cloud POS server 166. In some instances, the standard transaction data may be associated with a first identifier, such as a transaction identifier or transaction ID, which may be uniquely generated for a particular transaction. The detailed transaction data may also be associated with the same transaction ID, or may be instead associated with a more general identifier, such as a merchant ID (e.g., merchant ID 127). The detailed transaction data may identify a time of the transaction, or other information or combinations of information used to further uniquely identify the transaction. The VAS processor 165 includes a transaction connector module 168, which can be used to correlate particular standard transaction data received via the first channel with detailed transaction data received via the different second channel. The correlation process performed by the transaction connector module 168 may be any suitable algorithm for connecting the data, including associating those sets of data based on a first unique identifier associated with the standard transaction data and a second identifier associated with the detailed transaction data.

Once correlated, a merchant data analyzer 167 can be used to identify particular analyses, trends, or other insights associated with the obtained data. The merchant data analyzer 167 can analyze the correlated or associated data, and can compare the analysis to one or more VAS rules 178 used to identify a particular VAS provider 171, 185 and/or VAS operation to be performed based on the analyzed data. In some instances, the merchant data analyzer 167 may itself be a VAS provider 171, 185, which, in some instances, can be used to identify one or more additional VAS operations to be performed. The VAS rules 178 may include any number or types of rules used to evaluate whether a particular transaction (and the correlated transaction data) triggers or otherwise satisfies a particular VAS rule 178, where each of the VAS rules 178 are associated with a particular VAS provider 179. Each of the VAS providers 179 defined within the various VAS rules 178 may correspond to a VAS provider 171 or other internal action within the financial server 160 to be performed, or alternatively, an external VAS provider 185 or other service or external action to be performed based on the transaction. The VAS providers 171, 185 may be or may be associated with internal or external services, applications, operations, processes, or other activities or functionality to be performed based on a particular transaction. In some instances, each VAS rule 178 may be associated with a VAS provider 179, a set of VAS trigger criteria 180 defining when a particular operation is to be performed, and a set of VAS connection data 181 defining where and/or how a particular VAS provider 171, 185 can be accessed and/or communicated with. Using that connection data 181, a VAS communication engine 170 can provide the correlated transaction information (e.g., all or a portion thereof) to the corresponding VAS provider 179 (e.g., VAS provider 171 or 185), and allow the VAS provider to perform the VAS operations. The trigger criteria 180 may be associated only with the current transaction (e.g., as defined by a set of transaction details 175, illustrated as including, for example, an amount 176 of the transaction, as well as SKU information 177 (or tax-related information from the transaction) associated with the goods and/or services included in the transaction, as well as other information), or may be further associated with one or more sets of historical data 174 associated with a merchant account 173 (e.g., associated with the merchant corresponding to the POS 102 and the client device 120 from which the current transaction originated).

The VAS rules engine 169 can be used to access and evaluate the one or more VAS rules 178 and their various criteria 180, and, in response to identifying a particular value-added service to be performed, the VAS communication engine 170 can use the VAS connection data 181 associated with a satisfied VAS rule 178 to send the relevant transaction information (and, in some instances, the relevant historical information), to perform the further VAS operations. If the VAS provider 179 is an internal VAS provider 171, the transaction and other relevant information for the VAS operation can be sent internally within the financial server 160, and the operation can be performed. If, however, the VAS provider 179 corresponds to an external VAS provider 185, the relevant information can be transmitted to the external VAS provider 185 via network 135.

Any number of example VAS providers and/or operations can be used in the present application. In one example, the VAS operations may be associated with a business analysis performed by a particular VAS provider 171, 185, such as when the transaction is associated with a particular set of information, or where a cumulative amount of transactions meet a particular threshold (e.g., every 10 or 100 transactions), a business analysis based on the current transaction and a set of prior historical data 174 (e.g., a prior set of transactions over a period of time, over all time, etc.) may be provided to the VAS provider 179 identified in the VAS rule 178. The VAS provider 179 (e.g., VAS provider 171, 185) can perform the value-added service operation as it is defined, and can return a result of the analysis. In some instances, the result may be a particular analysis based on the current and/or historical transactions performed by the merchant. In some instances, the analysis may include an analysis of competitors based on public or proprietary information. In some instances, at least a portion of the analysis may be returned to the client device 120 or another merchant-related device or system, where the analysis can be presented or made available for review. In some instances, the analysis may include one or more concrete suggestions to the merchant based on the analysis.

In a second example of VAS operations, one or more financial product offers may be generated, proposed, or offered based on the current correlated transaction and/or one or more historical transactions. In such instances, a trend analysis may be performed, including an analysis based on a merchant-related account 173. Using the information available within the financial server 160 about the particular merchant, including information on the corresponding POSs 102 and client devices 120 used, one or more financial product offers may be identified and generated by the VAS provider 179 corresponding to the satisfied VAS rule(s) 178. In some instances, the VAS provider 179 may be associated with an offer engine, where, based on the input associated with the current and/or historical transactions, one or more offer-related rules are analyzed to determine whether particular financial offers are to be made to the merchant.

In some instances, location information may be obtained from either the POS 102, the POS application 123, or the client device 120, in connection with a particular transaction. The location information can include an exact location (e.g., a GPS location), location information related to a network (e.g., an IP address, a set of available wireless networks, etc.), or a merchant identifier associated with a particular location. The location information may be provided to a VAS provider 179 who can analyze the location information (and/or derive the particular location associated with the transaction) and determine whether the transaction is allowed at that particular location based on a geo-location-based comparison to allowed transaction locations. In some instances, particular cities, regions, or countries may be identified as allowed locations. In still other instances, a current location may be compared to an expected location of the user associated with the POS 102—if the location at which the transaction is attempted does not correspond to the allowed location, the VAS provider 179 may generate a notification and/or provide an indication not to allow the transaction to be fully processed, among other options.

In another example, the VAS provider 179 may link detailed transaction data to a merchant's accounting system, allowing for near-real-time updates to merchant systems based on the transaction.

The solution described throughout this disclosure and in FIG. 1 may be associated with an opt-out mechanism, allowing customers to specifically elect not to receive or perform some or all value-added services from the financial institution. In other instances, the solution may be associated with an opt-in process prior to performing the one or more value-added services and providing information to the VAS processor 165. All data may be stored in an encrypted format at the POS 102 and throughout communications and interactions within the illustrated system 100, with various security precautions taken to protect the data and secure information.

While portions of the elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate.

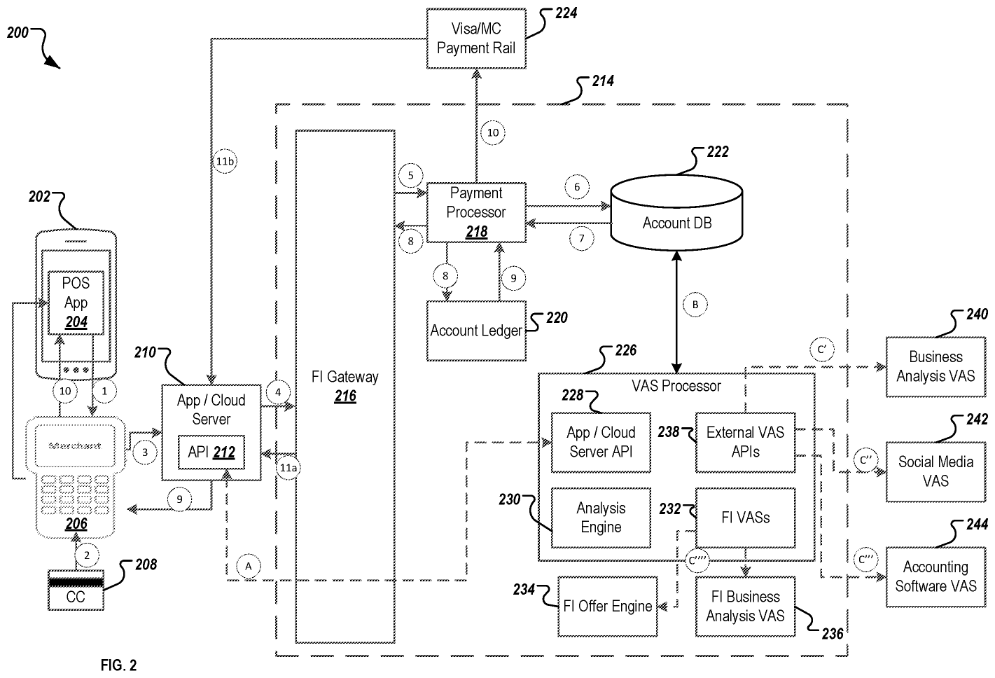

FIG. 2 is an illustration of components and interactions performed in an example system 200 for identifying and performing VASs based on detailed transactional information received at a cloud-based payment system. Portions of the description relate to the illustration of FIG. 1, although alternative implementations may be used to perform the actions illustrated in FIG. 2.

Initially, a transaction in accordance with a bill of sale or interaction is input into a POS app 204 executing at a client device 202. The transaction may be currently being made between a merchant and a customer at the location where both the client device 202 and the POS 206 are located, or the POS app 204 may transmit information related to the transaction to a remote POS 206. That transaction amount can then be provided or transmitted (at 1) to the merchant POS 206 (e.g., a remote terminal, which may be associated with the POS app 204 as described in FIG. 1).

At 2, a customer can provide a set of payment credentials to the POS 206, such as via a credit card 208, debit card, or other suitable payment information, including one or more mobile wallet payment methods, including card-based information provided via the mobile wallet. In order to complete the transaction, the POS 206 and/or the POS app 204 executing on the client device 202 can transmit or otherwise forward, via a communications module or interface, the payment credentials and the transaction amount to an associated app server 210 at 3, which may be provided as a cloud-based payment service. Communications to the app server 210 may be performed by sending information using API 212 or another entry point associated with the app server 210. As noted, either the POS 206 or the client device 202 may transmit the information at 3 in different implementations.

At 4, the app server 210 can forward the received payment credentials and transaction amount, as well as any other standard transaction information to a financial server or system 214 via payment gateway 216. The payment gateway 216 can then, at 5, forward the payment credentials, transaction amount, and the other information to the payment processor 218. The financial server 214, using the payment processor 218, can determine if the customer account from which the payment is made is held with financial institution associated with the financial server 214 based on an account database 222 (via 6, with results returned via 7). The payment processor 218, upon determining that the account is associated with the financial institution, can perform any internal adjustments to the account ledger 220 associated with the corresponding account via 8, with the results provided via 9. Based on the information, the transaction can be processed via the Visa/MasterCard payment rail 224, or any other suitable payment rail, using known or existing payment processing methods and operations (via 10). The results or confirmation of the completed transaction can be provided from the rail 224 back to the app server 210, either directly from the payment rail 224 (via 11b) or through the payment gateway 216 (via 11a). The confirmation may be provided securely through any suitable channel, and may be encrypted and sent through an unsecured channel, encrypted through a secure channel, or unencrypted through an otherwise secure channel.

In parallel to the standard transaction processing operations of 4 through 11, the present solution can provide an additional channel from the app server 210 to a VAS processor 226. The VAS processor 226 may be associated with or otherwise managed by the financial institution (including, within the financial server or system 214), while in other instances, the VAS processor 226 may be separate from or external to the financial institution. Communications to the VAS processor 226 can be provided through a distinct second channel different from the first channel used to provide the standard transaction information to the payment gateway 216. The information passed to the VAS processor 226 may be sent by or via one or more app server APIs 212, 228, which can share and/or transmit transaction information in a secure manner. Any other suitable interface or communication endpoint may be used instead or alternatively in different implementations, such that detailed transaction information can reach the VAS processor 226 accordingly.

Upon receipt at the VAS processor 226, an analysis engine 230 can be used to coordinate and correlate the detailed transaction information received at the VAS processor 226 to the standard transaction information received via the payment gateway 216. In some instances, the set of information received at the VAS processor 226 may be associated with at least one identifier, such as transaction identifier, a terminal identifier, a merchant identifier, or another suitable identifier, where the at least one identifier or a combination of the identifier and transaction information can uniquely identify the transaction and/or the merchant at which the transaction occurred. The detailed transaction information may include Level 2 or Level 3 card data. Level 2, or Level II, data can include the same information captured at Level 1 (e.g., the standard transaction information), plus one or more of the following: sales tax amount, customer's accounting code, a merchant's tax ID number, an applicable minority and women-owned business status, and sales outlet ZIP code. Level 2 data elements benefit the corporate/government/industrial buyer and can often be transmitted via a standard credit card point of sale terminal due to their restricted capabilities. Level 3, or Level III, data, can include the same information as captured at Level 1 and 2, plus one or more of the following: quantities, product codes, product descriptions, ship to ZIP, freight amount, duty amount, order/ticket number, unit of measure, extended item amount, discount indicator, discount amount, net/gross indicator, tax rate applied, tax type applied, debit or credit indicator and alternate tax identifier. Level 3 data represents a comprehensive line item detail, and may be similar to or equivalent to the information found on an itemized invoice. In some instances, only a portion of the Level 2 and/or Level 3 data may be provided to the VAS processor 226, where the detailed transaction information provided represents detailed information obtained from the client device 202 and/or the POS 206 regarding the transaction performed, such as information obtained from the client device 202 and/or backend merchant systems different than that typically provided to the financial institution during standard merchant transactions for the purposes of processing the transaction and payment credentials. For instance, location data obtained by either the POS app 204, another application executing on the client device 202, or by the POS 206, can be provided.

During the transaction processing, the detailed transaction information can be provided in real-time, or near real-time, to the VAS processor 226 (as shown by A). Using that information, the analysis engine 230 can identify one or more transactions, or sets of transactions, processed via the payment gateway 216 associated with the current detailed transaction information (as shown by B). The matching may be based on any number of relevant factors, including but not limited to (1) matching transaction identifiers associated with both the standard and detailed transaction information, (2) matching a transaction identifier associated with a time stamp to a merchant identifier associated with a similar time stamp, or any other suitable matching method. Any suitable relationship between identifiers or information associated with the standard transaction information and identifiers or information associated with the detailed transaction information can be used to match or associate pairs or sets of transaction data. In addition, from an encryption standpoint, a set of terminal master keys that are added to or included in the POS 102 device (e.g., keys to POS 131 and the cloud device link 110), can be matched or associated to ensure that the POS 102, the client device 120, and the servers 160 are providing valid information. Further encryption, digital signatures, and other related techniques can be used or combined to protect communication channels between components, encrypt and protect data provided during those communications, and/or any other information protection operations.

The VAS processor 226 may be associated with and/or in communication with one or more value-added services, either internal or external to the financial institution. In some instances, the VAS processor 226 can obtain additional customer information when the customer (that is, the party paying the merchant) is also a customer of the financial institution through its connection to the account database 222, as well as the account ledger 220, among other financial institution systems and accounts.

The VAS processor 226 can be associated with one or more rules used to determine the corresponding value-added services to be performed upon receiving and identifying a transaction. In some instances, the rules may be associated with different VAS providers, and determine whether the transaction information and any other data is provided to those providers for operations related to a particular value-added service. The rules considered and evaluated by the VAS processor 226 can be associated with any suitable service, and can be based on or can evaluate an individual transaction-related set of data, a set of collected historical data associated with the merchant, an individual transaction as considered in light of a set of collected historical data associated with the merchant, based on the receipt of a transaction without further analysis, or on any other suitable criteria. In response to identifying that at least one particular value-added service is to be performed, the VAS processor 226 can forward any suitable information needed by the particular value-added service via a known connection, which may be internal to or external from the financial institution. As illustrated in FIG. 2, information can be provided to external VASs, e.g., (an external business analysis VAS 240 (via C′), a social media-related VAS 242 (via C″), an accounting software VAS 244 (via C′″, such as a cloud-based accounting system)) via one or more external VAS APIs 238, or one or more internal VASs (e.g., an internal offer engine 234 (via C″″), or an internal business analysis VAS 236) via an internal FI VAS connection manager 232. The illustrated set of VASs are not meant to be exhaustive, but are meant to be an example set of value-added services to which the current system can connect and allow additional analyses and operations to be performed based on the additional data and information that is accessible in the present solution using the cloud-based payment solution.

In one example, the current transaction information (i.e., the standard transaction information and the detailed transaction information) can be identified to trigger a business analysis associated with the merchant. The analysis can provide analytics and other business-related analyses to the merchant via the client device 202, providing insights associated with current and historical transactions. In some instances, the analysis may identify one or more business-related suggestions or recommendations based on an analysis rule set. Based on the insights, one or more changes to the merchant's operations can be identified and returned to the merchant.

In some instances, based on the current transaction information in light of historical transactions, one or more financial offers can be identified by an offer engine 234 and can be provided to the merchant. Those offers may include, but are not limited to, considerations of one or more loan products, business credit cards, additional POSs 206 to be used to manage, or other information, such as based on amounts, timings, and other analyses or performed transactions for the merchant. The offer engine 234 can incorporate additional information about a particular merchant, particularly where the account database 222 and other account information in the financial institution provides information about the merchant and their ongoing business. For example, an analysis that the merchant's sales have increased at a particular rate over a period of time may be used, based on ongoing transaction analyses, to offer one or more relevant financial products typically used by growing businesses.

The social media VAS 242 may take information regarding particular transactions from the merchant and identify feedback and information from one or more social media sites, such as reviews received from particular customers regarding particular products or services related to transactions, information about customer satisfaction, and/or other relevant information. Using at least a part of the current transaction information, additional information and insight can be obtained using the social media VAS 242.

In other instances, transactional (both current and historical) information can be analyzed by a particular VAS as it relates to one or more competitors. For example, information regarding particular units sold (e.g., of a particular brand or product) may be compared by a particular VAS to one or more merchants in similar categories, geographic locations, and/or business lines. In some instances, for example, related products typically offered or purchases by customers when purchasing a particular product included in a current transaction may be identified and immediately can be offered at the POS 206 during, or directly after, the transaction.

In some instances, one or more value-added services may be triggered or initiated after periods of time, a certain number of transactions performed by the merchant, or in response to a particular event or transaction. In other words, a value-added service may not be identified by the VAS processor 226 after each transaction. Instead, the VAS processor 226 may monitor transactions for the particular criteria to be triggered, based on the cumulative transaction history of the merchant, including information associated with the current transaction. When the criteria is met, the particular value-added service can be triggered and results can be returned to the client device 202 or another suitable location.

In some instances, a particular VAS provider may have insight or access to information associated with a merchant's inventory. Based on the detailed information received via the app server 210, the particular SKUs associated with a transaction can be analyzed. Using that information, the VAS provider can compare a current stock level to an ordering threshold or minimum stock amount. In response to the VAS provider determining that the stock level is below an allowed minimum, the VAS provider can trigger a transaction to purchase an additional amount of stock. The determined replenishment operation can be automatically performed based on the information received and can use merchant payment credentials.

In still other instances, using the information obtained through the second channel and the combination of the detailed transaction information and the standard transaction information, one or more financial documents can be generated by the VAS processor 226 and/or one or more VAS providers. Any suitable processing or transaction analysis can be performed using the detailed information, which can include account reconciliation, account and financial system analyses, and any other operations. Should any discrepancies be identified by VAS process, a further process to identify the discrepancy can be triggered, either within the existing financial systems or by notification to a user of the need to further review.

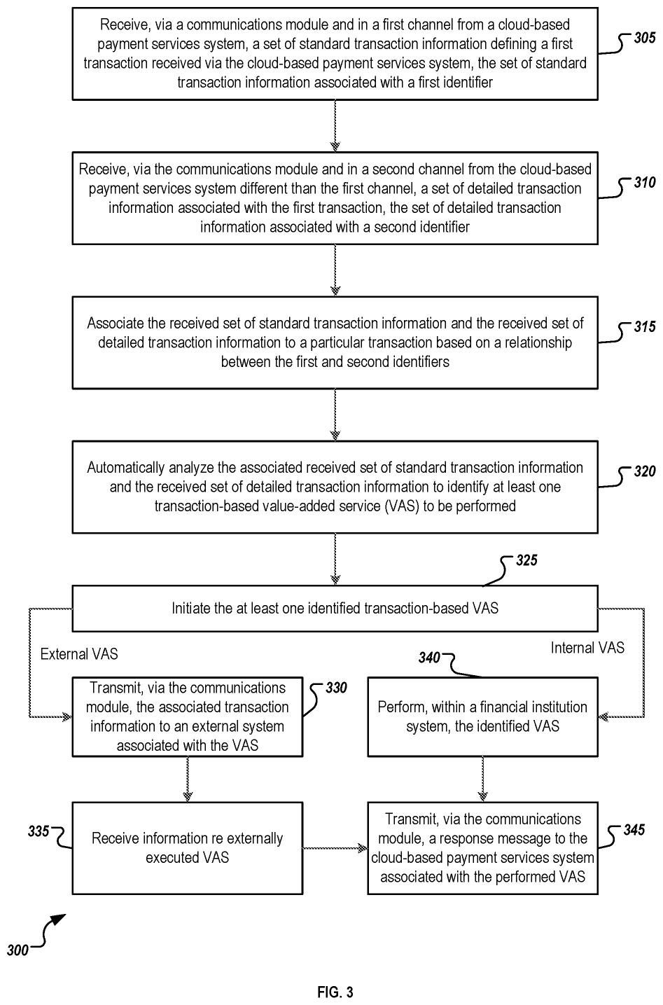

FIG. 3 is a flow diagram of an example method 300 for identifying and performing VASs based on detailed transactional information received from a cloud-based payment system in one particular example implementation. It will be understood that method 300 and related methods may be performed, for example, by any suitable system, environment, software, and hardware, or a combination of systems, environments, software, and hardware, as appropriate. For example, a system comprising a communications module, at least one memory storing instructions and other required data, and at least one hardware processor interoperably coupled to the at least one memory and the communications module can be used to execute method 300. In some implementations, the method 300 and related methods are executed by one or more components of the system 100 described above with respect to FIG. 1, or the components described in FIG. 2, among others.

At 305, a set of standard transaction information defining a first transaction is received via a communications module or interface from a cloud-based payment services system. The set of standard transaction information can include basic transaction information, including a transaction amount (e.g., a total purchase amount), a date and time of the transaction, and a merchant identifier. The set of standard transaction information can be received through a first channel associated with the cloud-based payment services system, and can be associated with a first identifier. The first identifier may uniquely identify the transaction, or may be used in combination with one or more portions of the standard set of information to uniquely identify the transaction. For example, the standard information may also identify a terminal identifier, and a combination of the terminal identifier, the merchant identifier, the time, and the amount can be used to uniquely identify the transaction. In some instances, the standard transaction information can include a transaction identifier. In general, the set of standard transaction information is used to process a payment received at the merchant, and can be received via a payment gateway associated with the financial institution associated with the processing of the transaction. In some instances, the standard transaction information may include Level 1 payment card processing data.

At 310, a set of detailed transaction information associated with the first transaction can be received via a communications module from the cloud-based payment services system. The set of detailed transaction information is received via a second communication channel different than the first communication channel, and may be separate from a payment processing or payment verification channel associated with the first communication channel. Instead, the second communication channel may be a communication channel from a cloud server of the cloud-based payment services system to or associated with a value-added services processor. The value-added services processor may be a component or portion of a financial institution, where the value-added services processor can perform operations to identify and initiate one or more value-added services based, at least in part, on the detailed transaction information received. The detailed transaction information may be associated with a second identifier. The second identifier may be any suitable identifier, and can include or comprise a merchant identifier.

At 315, the received set of standard transaction information and the received set of detailed transaction information are associated to a particular transaction based on a relationship between the first and second identifiers. In some instances, the first identifier may comprise a transaction identifier, while the second identifier comprises a merchant identifier. Both of the sets of transaction information may be associated with or include a timestamp, either based on the information received from the cloud-based payment system or based on metadata applied to the received data upon receipt from the system. In those instances, associating the sets of information may include determining a merchant identifier associated with the particular transaction identifier. A timestamp of the received set of standard transaction information can then be matched to the timestamp of the received set of detailed transaction data. Alternatively, any suitable method of matching the received data can be used. Where the received standard or detailed information includes a terminal ID, an analysis can be performed to identify which merchant the particular terminal ID corresponds to. The timestamp associated with the transaction can then be matched to the other received information associated with the merchant to match the standard and detailed transaction sets. In some instances, the first and second identifiers may match, or may include, within their own identifier, the other identifier (e.g., where one of the identifiers concatenates a merchant ID and a transaction ID, where the other identifier includes only one of the merchant ID or transaction ID). Different merchants and systems may format their identifiers differently, and different association techniques can be used a required to associate the different sets of data received between the two channels.

At 320, the associated sets of standard transaction information and the detailed transaction information are automatically analyzed to identify at least one transaction-based value-added service to be performed. The analysis may be triggered upon receipt of a particular transaction, a particular type of transaction, or a transaction meeting one or more predefined rules or triggering criteria. In some instances, the current transaction may be analyzed based on one or more prior transactions, or a set of historical transactions associated with the merchant. Any suitable criteria may be defined and analyzed by a value-added services processor as described herein. In some instances, two or more value-added services may be identified as having been triggered based on their associated criteria being met or exceeded. As noted, the criteria may be triggered based on any suitable rules, including rules associated with an amount spent on a particular transaction, a particular amount spent over a recent X transactions, an amount spent cumulatively on all transactions over a period of time, a particular set of items included in or associated with a particular transaction, a particular number of transactions performed over a period of time, and other suitable criteria.

At 325, the particular identified value-added services are initiated. For external value-added services, relevant information associated with the transaction can be transmitted, using the communications module, to the external system associated with the value-added service at 330. At 335, via the communications module, information associated with the externally executed value-added service may be received, and method 300 can continue at 345. If the identified value-added service to be initiated is internal to the financial institution, an internal communication or message may be used to trigger and perform the internal value-added service at 340. Once performed, method 300 can continue at 345.

At 345, a response message can be transmitted, via the communications module, to the cloud-based payment services system. The response message can be provided back to a client device or system associated with the merchant, and may be any particular type of message. In some instances, the message may be presented in real-time at the client system while the transaction is being performed. In others, where a particular value-added service is not specific to the current transaction or relevant to completing the transaction, the response message and any related information may be sent to a messaging account of the merchant, such as an email or instant messaging client, where any results of the analysis can be reviewed. If the value-added service is relevant to or may affect the current transaction, the information can be sent to a POS device of the merchant, where the merchant may be able to take immediate or concurrent action (e.g., offer a related product or service based on the results of the value-added service). In some instances, notification of an automatic operation performed by the value-added service may be transmitted to the merchant, such as an automatic replenishment operation performed in response to a stock or inventory analysis performed based on information regarding goods or services performed and identified by the detailed transaction information. In some instances, the response message may include recommendations of actions to be performed by the merchant, including recommendations based on a business analysis-related value-added service, a set of external data obtained and analyzed in light of a current transaction in light of one or more historical transactions, or based on any other suitable analysis or operation.

The preceding figures and accompanying description illustrate example processes and computer-implementable techniques. However, system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, the described systems and flows may use processes and/or components with or performing additional operations, fewer operations, and/or different operations, so long as the methods and systems remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A system comprising:
a communications module;
at least one memory storing instructions, a plurality of account profiles, and a repository of transaction-based value added service definitions, each transaction-based value added service definition defining at least one automatic operation to be performed based on a set of criteria associated with at least one particular transaction and a corresponding set of information associated with the particular transaction;
at least one hardware processor interoperably coupled with the at least one memory and the communications module, wherein the instructions instruct the at least one hardware processor to:
receive, via the communications module and in a first channel from a cloud-based payment services system, a set of standard transaction information defining a first transaction received via the cloud-based payment services system, the set of standard transaction information associated with a first unique identifier;
receive, via the communications module and in a second channel from the cloud-based payment services system, a set of detailed transaction information associated with the first transaction different from the set of transaction information, the set of detailed transaction information associated with a second unique identifier, the second channel different than the first channel;
associate the received set of standard transaction information and the received set of detailed transaction information to a particular transaction based on a relationship between the first and second unique identifiers;
automatically analyze the associated received set of standard transaction information and the received set of detailed transaction information to identify at least one transaction-based value-added service to be performed for the particular transaction; and
initiate the at least one identified transaction-based value-added service.

2. The system of claim 1, wherein the received set of standard transaction information comprises Level 1 card data associated with the first transaction, and wherein the set of detailed transaction information associated with first transaction comprises at least one of Level 2 or Level 3 card data associated with the first transaction.

3. The system of claim 1, wherein the first channel comprises a payment verification channel from the cloud-based payment services system to a financial institution, and wherein the second channel comprises output from a value-added service application programming interface from the cloud-based payment services system.

4. The system of claim 1, wherein the first unique identifier of the received set of standard transaction information and the second unique identifier of the received set of detailed transaction information comprise a unique transaction identifier, and wherein associating the received set of standard transaction information and the received set of detailed transaction information to a particular transaction based on a relationship between the first and second unique identifiers comprises matching the first and second unique identifiers.

5. The system of claim 1, wherein the first unique identifier of the received set of standard transaction information comprises a transaction identifier, wherein the second unique identifier of the received set of detailed transaction information comprises a merchant identifier, wherein the received set of standard transaction information includes a timestamp of the transaction, and wherein the received set of detailed transaction information includes a timestamp, and wherein associating the received set of standard transaction information and the received set of detailed transaction information to a particular transaction based on a relationship between the first and second unique identifiers comprises:
determining a merchant identifier associated with the transaction identifier; and
matching the timestamp of the received set of standard transaction information to the timestamp of the received set of detailed transaction data.

6. The system of claim 1, wherein at least some of the transaction-based value added service definitions are associated with criteria evaluated based on the particular set of standard transaction and detailed transaction data associated with a particular transaction in combination with an analysis of that particular transaction in relation to a historical set of transactions associated with the account profile of a particular merchant associated with the particular transaction.

7. The system of claim 6, wherein initiating the at least one identified transaction-based value-added service comprises:
identifying, based on the particular set of standard transaction and detailed transaction data associated with a particular transaction in combination with an analysis of that particular transaction in relation to a historical set of transactions associated with the account profile of a particular merchant associated with the particular transaction, at least one financial product associated with the merchant to be offered;
generating an offer based on the at least one identified financial product; and
transmitting, via communications module, a message to the cloud-based payment services system including the generated offer.

8. The system of claim 1, wherein initiating the at least one identified transaction-based value-added service comprises:
identifying, based on the particular set of detailed transaction data associated with a particular transaction, a set of goods transacted in the particular transaction;
analyzing a merchant account identifying a current stock associated with goods offered by the merchant;
determining, from the merchant account, that additional stock of at least one of the set of goods transacted in the particular transaction is to be replenished based on an amount of the set of goods transacted; and
automatically initiating a replenishment operation based on the amount of the set of goods transacted in the particular transaction and on the determination.

9. A non-transitory, computer-readable medium storing computer-readable instructions executable by a computer and configured to:
receive, in a first channel from a cloud-based payment services system, a set of standard transaction information defining a first transaction received via the cloud-based payment services system, the set of standard transaction information associated with a first unique identifier;
receive, in a second channel from the cloud-based payment services system, a set of detailed transaction information associated with the first transaction different from the set of transaction information, the set of detailed transaction information associated with a second unique identifier, the second channel different than the first channel;
associate the received set of standard transaction information and the received set of detailed transaction information to a particular transaction based on a relationship between the first and second unique identifiers;
automatically analyze the associated received set of standard transaction information and the received set of detailed transaction information to identify at least one transaction-based value-added service to be performed for the particular transaction; and
initiate the at least one identified transaction-based value-added service.

10. The computer-readable medium of claim 9, wherein the received set of standard transaction information comprises Level 1 card data associated with the first transaction, and wherein the set of detailed transaction information associated with first transaction comprises at least one of Level 2 or Level 3 card data associated with the first transaction.

11. The computer-readable medium of claim 9, wherein the first channel comprises a payment verification channel from the cloud-based payment services system to a financial institution, and wherein the second channel comprises output from a value-added service application programming interface from the cloud-based payment services system.

12. The computer-readable medium of claim 9, wherein the first unique identifier of the received set of standard transaction information and the second unique identifier of the received set of detailed transaction information comprise a unique transaction identifier, and wherein associating the received set of standard transaction information and the received set of detailed transaction information to a particular transaction based on a relationship between the first and second unique identifiers comprises matching the first and second unique identifiers.

13. The computer-readable medium of claim 9, wherein the first unique identifier of the received set of standard transaction information comprises a transaction identifier, wherein the second unique identifier of the received set of detailed transaction information comprises a merchant identifier, wherein the received set of standard transaction information includes a timestamp of the transaction, and wherein the received set of detailed transaction information includes a timestamp, and wherein associating the received set of standard transaction information and the received set of detailed transaction information to a particular transaction based on a relationship between the first and second unique identifiers comprises:
determining a merchant identifier associated with the transaction identifier; and
matching the timestamp of the received set of standard transaction information to the timestamp of the received set of detailed transaction data.

14. The computer-readable medium of claim 9, wherein at least some of the transaction-based value added service definitions are associated with criteria evaluated based on the particular set of standard transaction and detailed transaction data associated with a particular transaction in combination with an analysis of that particular transaction in relation to a historical set of transactions associated with an account profile of a particular merchant associated with the particular transaction.

15. The computer-readable medium of claim 9, wherein initiating the at least one identified transaction-based value-added service comprises:
identifying, based on the particular set of standard transaction and detailed transaction data associated with a particular transaction in combination with an analysis of that particular transaction in relation to a historical set of transactions associated with an account profile of a particular merchant associated with the particular transaction, at least one financial product associated with the merchant to be offered;
generating an offer based on the at least one identified financial product; and
transmitting, via communications module, a message to the cloud-based payment services system including the generated offer.

16. The computer-readable medium of claim 9, wherein initiating the at least one identified transaction-based value-added service comprises:
identifying, based on the particular set of detailed transaction data associated with a particular transaction, a set of goods transacted in the particular transaction;
analyzing a merchant account identifying a current stock associated with goods offered by the merchant;
determining, from the merchant account, that additional stock of at least one of the set of goods transacted in the particular transaction is to be replenished based on an amount of the set of goods transacted; and
automatically initiating a replenishment operation based on the amount of the set of goods transacted in the particular transaction and on the determination.

17. A computerized method performed by one or more processors, the method comprising:
receiving, in a first channel from a cloud-based payment services system, a set of standard transaction information defining a first transaction received via the cloud-based payment services system, the set of standard transaction information associated with a first unique identifier;
receiving, in a second channel from the cloud-based payment services system, a set of detailed transaction information associated with the first transaction different from the set of transaction information, the set of detailed transaction information associated with a second unique identifier, the second channel different than the first channel;
associating the received set of standard transaction information and the received set of detailed transaction information to a particular transaction based on a relationship between the first and second unique identifiers;
automatically analyzing the associated received set of standard transaction information and the received set of detailed transaction information to identify at least one transaction-based value-added service to be performed for the particular transaction; and
initiating the at least one identified transaction-based value-added service.

18. The method of claim 17, wherein the received set of standard transaction information comprises Level 1 card data associated with the first transaction, and wherein the set of detailed transaction information associated with first transaction comprises at least one of Level 2 or Level 3 card data associated with the first transaction.

19. The method of claim 17, wherein the first channel comprises a payment verification channel from the cloud-based payment services system to a financial institution, and wherein the second channel comprises output from a value-added service application programming interface from the cloud-based payment services system.

20. The method of claim 17, wherein the first unique identifier of the received set of standard transaction information and the second unique identifier of the received set of detailed transaction information comprise a unique transaction identifier, and wherein associating the received set of standard transaction information and the received set of detailed transaction information to a particular transaction based on a relationship between the first and second unique identifiers comprises matching the first and second unique identifiers.
